(19) United States
(12) Patent Application Publication
(10) Pub. No.: US 2007/0067541 A1
(43) Pub. Date: Mar. 22, 2007

(54) Method and apparatus for automatically adjusting bus widths

(75) Inventor: Chao-Huang Chang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/394,841

(22) Filed: Mar. 30, 2006

(30) Foreign Application Priority Data
Aug. 25, 2005 (TW) 94129048

(51) Int. Cl. G06F 13/40

(52) U.S. Cl. 710/307

(57) ABSTRACT

A method for automatically adjusting bus widths for a first slot and a second slot of a riser card according to the number of interface cards inserted to the slots. Half of the bus width for the first slot is predetermined for transferring signals. First, a detecting unit detects whether an interface card is inserted in the second slot of the riser card, if so, the detecting unit outputs a second slot enabling signal, or else, the detecting unit outputs a second slot disabling signal. A control unit is used for receiving the second slot enabling signal or the second slot disabling signal, and enabling half of the bus width for the second slot for transferring signals if the second slot enabling signal is received, or enabling the other half of the bus width for the first slot for transferring signals if the second slot disabling signal is received.

### BACKGROUND OF THE INVENTION

1. Field of the Invention

The present invention relates generally to a method and apparatus for automatically adjusting bus widths, and more particularly, to a method and apparatus for adjusting bus widths for the slots in a riser card according to the number of interface cards inserted therein.

2. Description of Related Art

In recent years, Peripheral Component Interconnect (referred to as PCI hereinafter) has become one of the most popular Input/Output (referred to as I/O hereinafter) interconnecting interfaces. PCI is a kind of bus specification on the motherboards of the computers, and is mainly used to connect and transfer data between a variety of chipsets on the motherboards, such as a South bridge, a North bridge, a Central Processing Unit (CPU) and the like. A peripheral apparatus, such as a network card, an IDE hard disk, a SATA, a display card and the like, cannot run normally until being connected to a bus.

However, with the bandwidth requirement of future I/O apparatuses (for example, Gigabit Ethernet card, disk array card and serial advanced technology attachment (ATA) controller), PCI (133 MBps, 32 bits, total bandwidth of 33 MHz) becomes a limitation. In addition, the more the additional apparatuses are added, the more noises are produced in the bus. Without doubt, the noises are likely to make signals unclear and degrade the quality of data transferred over the bus.

Accordingly, PCIe (also referred to as PCI Express or PCI-E) is considered as a new-generation I/O interface for substituting PCI to provide much wider bandwidth. The primary improvement is in that the previously shared bandwidth is arranged orderly for the devices connected thereto based on their priority via a switch, obtaining point-to-point independent access priority. In addition, PCIe does not adopt the architecture of a PCI common bus, but instead each set of PCIe owns an independent transmission channel, which avoids data interference, thus data transmission speed of a PCIe bus is much faster that a conventional PCI bus.

There are five common types of PCIe: x1, x2, x4, x8 and x16, each type having an exclusive slot. At present, the transmission speed of a PCIe simplex channel can reach 250 MBs which is almost double the speed of a general PCI while the speed of x16 PCIe can even reach 16 GB/s. Therefore, presently PCIe is mainly applied in products that require large bandwidth, such as a display card. Nowadays, when signals received or transmitted by the chipsets are transferred through PCIe bus with eight bits in total bus width on a riser card, a single PCIe interface card assembled on the riser card with one single PCIe slot regularly receives and transmits 8-bit PCIe signals. If two PCIe interface cards are assembled on the riser card having two PCIe slots, each of the PCIe interface cards receives and transmits only 4-bit PCIe signals. However, when only one PCIe interface card is assembled on the riser card with two PCIe slots, only the bus width of four bits is used to transfer signals. Under such a mechanism, transmission speed of the signal is evidently confined. Accordingly, there exists a strong need in the art for a method and apparatus to allow bus width on a riser card with two PCIe slots to be fully utilized for signal transmission, regardless the number of interface cards inserted thereto.

### SUMMARY OF THE INVENTION

Accordingly, it is a primary objective of the present invention to solve the problems of the aforementioned conventional technology by providing a method and apparatus for automatically adjusting bus width for a riser card slots to fully utilize the bus width.

It is another objective of the present invention to provide a method and apparatus for automatically adjusting bus widths to allow efficient signal transmission.

In order to attain the objectives mentioned above and the others, a method and apparatus for automatically adjusting bus width according to the present invention are provided. The method is applicable to a riser card having a first slot and a second slot for insertion of interface cards, so as to make the riser card automatically adjust bus width according to the number of the interface cards inserted in the slots. Half of the bus width for the first slot is predetermined to transfer signals. The method and apparatus mainly employ a detecting unit to detect whether the second slot is inserted with an interface card, and output a second slot disabling signal or second slot enabling signal accordingly. The method and the apparatus further employs a control unit to adjust the bus width of the first slot or the second slot according to the second slot disabling signal or the second slot enabling signal.

Compared with the conventional technology, the bus widths of the first slot and the second slot are controlled by automatically detecting the presence of an interface card in the second slot in the present invention. Therefore, despite the riser card is installed with a single interface card or two interface cards, the bus widths of the riser card are still fully utilized to transfer signals efficiently, thereby achieving the aforementioned primary and other objectives.

### BRIEF DESCRIPTION OF DRAWINGS

FIG. 1 depicts a flow chart of the method for automatically adjusting bus widths according to the present invention;

FIG. 2 depicts a schematic diagram of a riser card slot, corresponding interface card and a detecting unit of the apparatus for automatically adjusting bus widths according to the present invention; and

FIG. 3 depicts a block diagram of the apparatus for automatically adjusting bus widths according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention.

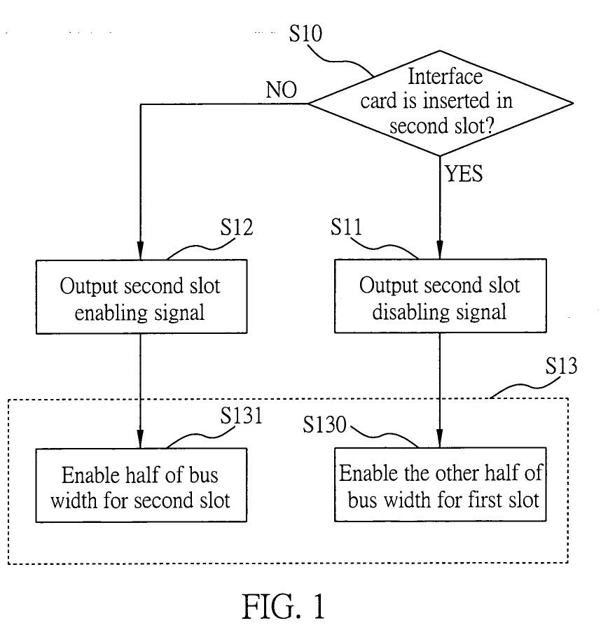

FIGS. 1 to 3 are used to illustrate the method and apparatus for automatically adjusting bus width according to the present invention. The preferred embodiment of the method and apparatus for automatically adjusting bus width according to the present invention will be described in the descriptions below in conjunction with the accompanying drawings. Wherein, attention should be paid to that the drawings are all simplified schematic diagrams, and merely illustrate the basic steps flow of the method and primary structure of the apparatus according to the present invention in a non-limiting sense. Only those pertaining to the present invention are illustrated in the drawings.

FIG. 1 is a flow chart of the method for automatically adjusting bus width according to the present invention. The method is applicable to a riser card (for example a PCIe riser card according to the preferred embodiment) having a first slot and a second slot for insertion of interface cards (for example PCIe interface cards according to the preferred exemplary embodiment), so as to make the riser card automatically adjust its bus width according to the number of the interface cards inserted. Half of the total bus width for the first slot is preset by default for transferring signals. According to the preferred embodiment, both the first slot and the second slot are PCIe slots, and the riser card is installed on a motherboard of a computer (e.g., a desktop computer, a super computer and a server computer and the like), so as to exchange signals with a variety of chipsets, such as a Southbridge, a Northbridge, a Central Processing Uunit (CPU) and the like in the computer. The method begins in step S10.

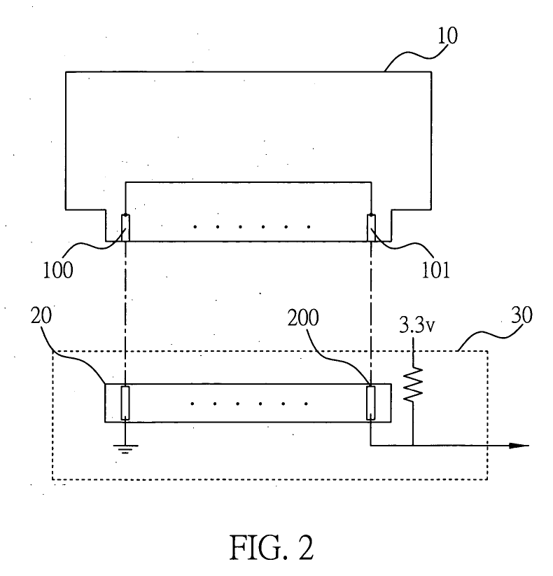

In step S10, detecting whether an interface card is inserted in the second slot. If no card is detected to be present in the second slot, step S11 is then executed to output a second slot disabling signal; on the other hand, if a card is detected to be present in the second slot, step S12 is then executed to output a second slot enabling signal. A detecting unit 30 (shown in FIG. 2) is used to detect whether the second slot is inserted with an interface card. The detecting unit is electrically connected with the second slot and outputs either the second slot enabling signal or the second slot disabling signal based on whether a card is detected to be present in the second slot.

The preferred embodiment of the detecting unit 30 is illustrated in FIG. 2. The second slot 20 and an interface card 10, which is about to be inserted into the second slot 20, are also illustrated in FIG. 2. When the interface card 10 is inserted into the second slot 20, two pins 100 and 101 of the interface card 10 are shorted to each other and electrically connected with the detecting unit 30, and the detecting unit 30 thus outputs the second slot enabling signal; on the other hand, if the second slot 20 is not installed with any interface card, an open state is formed between the detecting unit 30 and the second slot 20, and the detecting unit 30 thus outputs the second slot disabling signal. Both of the second slot enabling signal and the second slot disabling signal are outputted based on a “present” pin 200 of the second slot 20, the second slot enabling signal is a low-level signal, and the second slot disabling signal is a high-level signal. Then proceed to step S13.

In step S13, the bus width of the first slot or the second slot is adjusted according to the second slot disabling signal or the second slot enabling signal. If the second slot enabling signal is outputted, proceed to step S131, during which half of the bus width for the second slot is enabled for transferring signals. If the second slot disabling signal is output, proceed to step S130, during which the other half of the bus width for the first slot is enabled for transferring signals.

The bus width of the first slot or the second slot is adjusted by a control unit according to the second slot disabling signal or the second slot enabling signal. The control unit is electrically connected with the detecting unit 30, the first slot 21 and the second slot 20 to receive the second slot enabling signal or the second slot disabling signal outputted from the detecting unit 30, and output a second slot bus width enabling signal or a first slot bus width disabling signal respectively corresponding to the second slot enabling signal or the second slot disabling signal, so as to enable half of the bus width for the second slot or the other half of the bus width for the first slot. Therefore, when the control unit receives the second slot enabling signal outputted from the detecting unit 30, which implies that the interface card 10 is inserted into the second slot 20, the control unit outputs the second slot bus width enabling signal, so as to enable half of the bus width for the second slot according to the second slot bus width enabling signal. On the other hand, when the control unit receives the second slot disabling signal outputted from the detecting unit 30, which implies that the second slot 20 is not installed with any interface card, the control unit outputs the first slot bus width enabling signal, so as to enable the other half of the first bus width of the first slot 21 previously not enabled according to the second slot bus width disabling signal.

For example, assuming both of the first slot 21 and the second slot 20 have a bus width of eight bits and that four bits of the first bus width for the first slot is predetermined for transferring signals. When the interface card 10 is inserted into the second slot 20, the control unit automatically enables four bits of the second bus width for the second slot 20 to transfer signals. If the second slot 20 is not installed with any interface card, the control unit automatically enables the other four bits of the bus width assigned to the first slot. Therefore, the first slot 21 is to transfer signals with eight bits, two times as many as four bits. According to the preferred embodiment, the control unit is a switch, e.g., a switch with model number of PI2PCIE412-C.

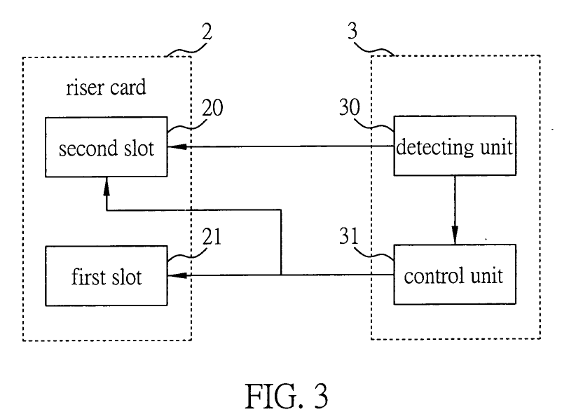

Furthermore, an apparatus for automatically adjusting bus widths 3 corresponding to the method for automatically adjusting bus widths is further provided according to the present invention. As shown in FIG. 3, the apparatus 3 is applicable to a riser card 2 having the first slot 21 and the second slot 20 for insertion of interface cards, so as to allow the riser card 2 to automatically adjust the bus width of the first slot 21 or the second slot 20 according to the number of the interface cards inserted into the second slot 20. Half of the bus width for the first slot 20 is preset to transfer signals. The apparatus 3 at least comprises a detecting unit 30 and a control unit 31 electrically connected to the detecting unit 30.

The detecting unit 30 is used to detect whether the second slot 20 is inserted with an interface card. If so, the second slot enabling signal is outputted, else the second slot enabling signal is outputted.

The control unit 31 is used to receive the second slot enabling signal and the second slot disabling signal outputted from the detecting unit 30, and adjust the bus width of the first slot 21 or the second slot 20 according to the second slot disabling signal or the second slot enabling signal. If the second slot enabling signal is outputted, the control unit 31 enables half of the bus width for the second slot 20 to transfer signals. If the second slot disabling signal is outputted, the control unit 31 enables the other half of the bus width for the first slot 21 to transfer signals. The detecting unit 30 and the control unit 31 described herein are identical to what disclosed in method for automatically adjusting bus widths, so they will not be further described.

The technical feature and exemplary embodiment according to the present invention can be clearly learned from the above-discussed description and accompanying drawings, the present invention mainly employs a detecting unit to detect whether the second slot has an interface card or not and output a second slot enabling signal or a second slot disabling signal correspondingly, then employs a control unit to adjust bus width for the first slot or the second slot according to the second slot disabling signal or the second slot enabling signal, respectively. Accordingly, bus width of the first slot or the second slot is controlled through detection of the presence of an interface card in the second slot in the present invention, thus, whether a single piece of interface card or two pieces of interface cards are inserted, bus width can be fully utilized to perform signal transferring operation efficiently.

The above-described exemplary embodiments are to describe various objects and features of the present invention as illustrative and not restrictive. A person of ordinary skilled in the art would recognize that modifications and changes could be made in form and detail without departing from the sprit and the scope of the invention. Thus, the right protective scope of the present invention should fall within the appended claim.

What is claimed is:

1. A method for automatically adjusting bus widths for a first slot and a second slot of a riser card according to the number of interface cards inserted to the slots, half of the bus width for the first slot being predetermined for transferring signals, the method comprising the steps of:
detecting whether an interface card is inserted in the second slot of the riser card, if so, outputting a second slot enabling signal, or else, outputting a second slot disabling signal; and
enabling half of the bus width for the second slot for transferring signals if the second slot enabling signal is outputted, or enabling the other half of the bus width for the first slot for transferring signals if the second slot disabling signal is outputted.

2. The method for automatically adjusting bus widths of claim 1, wherein the step of detecting whether an interface card is inserted to the second slot of the riser card is performed by a detecting unit electrically connected to the second slot.

3. The method for automatically adjusting bus widths of claim 2, wherein if an interface card is inserted in the second slot, two shorted pins of the interface card allow the second slot to be electrically connected to the detecting unit, and the detecting unit outputs the second slot enabling signal, and if the second slot is not installed with any interface card, an open state is formed between the detecting unit and the second slot, and the detecting unit outputs the second slot disabling signal.

4. The method for automatically adjusting bus widths of claim 1, wherein either the second slot enabling signal or the second slot disabling signal is outputted based on a pin of the second slot.

5. The method for automatically adjusting bus widths of claim 4, wherein the second slot enabling signal is a low-level signal and the second slot disabling signal is a high-level signal.

6. The method for automatically adjusting bus widths of claim 3, wherein the step of enabling the bus width for the first slot or the second slot is performed by a control unit electrically connected with the detecting unit, the first slot and the second slot.

7. The method for automatically adjusting bus widths of claim 6, wherein the control unit is adapted to receive one of the second slot enabling signal and the second slot disabling signal outputted from the detecting unit, and output a second slot bus width enabling signal to enable the half of the bus width for the second slot according to the second slot enabling signal or output a first slot bus width enabling signal to enable the other half of the bus width for the first slot according to the second slot disabling signal.

8. The method for automatically adjusting bus widths of claim 7, wherein the control unit is a switch.

9. The method for automatically adjusting bus widths of claim 8, wherein the switch has a model type of PI2PCIE412-C.

10. The method for automatically adjusting bus widths of claim 1, wherein the total bus width available for each of the first slot and the second slot is eight.

11. The method for automatically adjusting bus widths of claim 1, wherein both the first slot and the second slot are Peripheral Component Interconnect Express (PCIe) slots.

12. The method for automatically adjusting bus widths of claim 1, wherein the riser card is installed on a motherboard of a computer, for exchanging signals with at least one of a Southbridge, a Northbridge and a Central Processing Unit (CPU) of the computer.

13. The method for automatically adjusting bus widths of claim 12, wherein the computer is one selected from the group consisting of a desktop computer, a super computer and a server computer.

14. The method for automatically adjusting bus widths of claim 1, wherein the riser card is a PCIe riser card.

15. The method for automatically adjusting bus widths of claim 1, wherein the interface card is a PCIe interface card.

16. An apparatus for automatically adjusting bus widths for a first slot and a second slot of a rise card according to the number of interface cards inserted in the slots, half of the bus width for the first slot being predetermined for transferring signals, the apparatus comprising:
a detecting unit for detecting whether an interface card is inserted in the second slot of the riser card, if so, outputting a second slot enabling signal, or else, outputting a second slot disabling signal; and
a control unit for receiving the second slot enabling signal or the second slot disabling signal outputted from the detecting unit, and enabling half of the bus width for the second slot for transferring signals if the second slot enabling signal is received, or enabling the other half of the bus width for the first slot for transferring signals if the second slot disabling signal is received.

17. The apparatus for automatically adjusting bus widths of claim 16, wherein the detecting unit is electrically connected with the second slot for outputting either the second slot enabling signal or the second slot disabling signal corresponding to the second slot.

18. The apparatus for automatically adjusting bus widths of claim 17, wherein if an interface card is inserted in the second slot, two shorted pins of the interface card allow the second slot to be electrically connected to the detecting unit, and the detecting unit outputs the second slot enabling signal, and if the second slot is not installed with any interface card, an open state is formed between the detecting unit and the second slot, and the detecting unit outputs the second slot disabling signal.

19. The apparatus for automatically adjusting bus widths of claim 16, wherein either the second slot enabling signal or the second slot disabling signal is outputted based on a pin of the second slot.

20. The apparatus for automatically adjusting bus widths of claim 19, wherein the second slot enabling signal is a low-level signal and the second slot disabling signal is a high-level signal.

21. The apparatus for automatically adjusting bus widths of claim 16, wherein the control unit is connected with the detecting unit, the first slot and the second slot, for controlling the first slot and the second slot to transfer signals.

22. The apparatus for automatically adjusting bus widths of claim 21, wherein the control unit is adapted to receive one of the second slot enabling signal and the second slot disabling signal outputted from the detecting unit, and output a second slot bus width enabling signal to enable the half of the bus width for the second slot according to the second slot enabling signal or output a first slot bus width enabling signal to enable the other half of the bus width for the first slot according to the second slot disabling signal.

23. The apparatus for automatically adjusting bus widths of claim 16, wherein the control unit is a switch.

24. The apparatus for automatically adjusting bus widths of claim 23, wherein the switch has a model type of PI2PCIE412-C.

25. The apparatus for automatically adjusting bus widths of claim 16, wherein the total bus width available for each of the first slot and the second slot is eight.

26. The apparatus for automatically adjusting bus widths of claim 16, wherein both the first slot and the second slot are Peripheral Component Interconnect Express (PCIe) slots.

27. The apparatus for automatically adjusting bus widths of claim 16, wherein the riser card is installed on a motherboard of a computer, for exchanging signals with a Southbridge, a Northbridge and a CPU of the computer.

28. The apparatus for automatically adjusting bus widths of claim 27, wherein the computer is one selected from the group consisting of a desktop computer, a super computer and a server computer.

29. The apparatus for automatically adjusting bus widths of claim 16, wherein the riser card is a PCIe riser card.

30. The apparatus for automatically adjusting bus widths of claim 16, wherein the interface card is a PCIe interface card.
